(19) United States
(12) Patent Application Publication
(10) Pub. No.: US 2010/0157061 A1
(43) Pub. Date: Jun. 24, 2010

(54) DEVICE AND METHOD FOR HANDHELD DEVICE BASED VEHICLE MONITORING AND DRIVER ASSISTANCE

(76) Inventors: Igor Katsman, Haifa (IL); Denis Nudel, Haifa (IL)

Correspondence Address: Pearl Cohen Zedek Latzer, LLP, 1500 Broadway, 12th Floor, New York, NY, 10036, US

(21) Appl. No.: 12/343,710

(22) Filed: Dec. 24, 2008

(51) Int. Cl. H04N 7/18

(52) U.S. Cl. 348/149; 348/E07.085

(57) ABSTRACT

A method of operating a general purpose handheld communication device to monitor traffic events is disclosed. The handheld communication device is detachably mountable on a vehicle and includes a motion sensor, a video imaging sensor, a data processor, data storage medium, and data communication module. The method includes acquiring motion data using the motion sensor; identifying a traffic event based on the motion data; acquiring visual data using the video imaging sensor; saving data that includes the acquired visual data and motion data on the data storage medium; and communicating the saved data using the communication module.

### FIELD OF THE INVENTION

The present invention relates to vehicle monitoring. More particularly, the present invention relates to a device and method for handheld device based vehicle monitoring and driver assistance.

### BACKGROUND OF THE INVENTION

According to data from the World Health Organization, almost 1.2 million people die annually (over 3,000 each day) in road traffic accidents around the world, and another 20-50 million people suffer from injuries. This accounts for 2.2 % of deaths in the world and the estimated cost of traffic accidents on the roads is 518 billion US dollars.

More than 95% of vehicle accidents involve some degree of improper driver behavior. While drivers may blame road conditions, equipment failure, or other drivers for those accidents, their own behavior is often the primary cause. One existing solution to determine the cause of an accident is to install a dedicated “black box” in the vehicle. The black box assists the driver and records critical events for further treatment, such as crash investigation, or evaluation and improvement of driver behavior.

One proposed solution is the video event data recorder (VEDR) black box. A VEDR black box is a device which records video and other relevant information inside and outside a vehicle. The purpose of the recording is to create a record of an event, such as an accident, and to enable evaluation of driver and vehicle performance before, during and after the event. For example, Denson in US2007/0257781, and Etcheson in US2007/0257782 and in US2007/0260361, describe methods for distinguishing an event of interest from other data, and recording the data associated with the event. Miller in US2007/0260363 describes a method to determine when to transmit data from a vehicle mounted monitoring system to a system server. Gunderson et al. in US2007/0268158, US2007/0257815, and US2007/0257804, describe methods for analyzing recorded event data and rating the safety of drivers and vehicles. The results of the rating may be applied, for example, to adjusting the cost of insurance coverage or for determining the necessity of driver training. Other aspects of vehicle monitoring systems are also discussed by Jeng (US2004/0267419), Richardson (US2008/0049830), Stanley (US2008/0043736), Blanco et al. (U.S. Pat. No. 7,023,333), Plante et al. (US2008/0122288), Plante (US2007/0132773, US2007/0136076, US2007/0136078, US2007/0135980, US2007/0135979, US2007/0219685), and Raisinghani et al. (US2005/0185052).

Another proposed solution is an on-board driving assistance system. A driving assistance system provides data for decision-making applications to assist a driver. For example, Stein et al. describe methods for analyzing image data to detect traffic signs (in US2008/0137908), and for detecting a yellow line (US2008/0043099). Stein et al. in US2007/0154068 describe a method of analyzing image data acquired from a moving vehicle to estimate the distance to an object. Shashua et al. in US2007/0230792 and Boyles et al. in US2007/0229238 describe methods for detecting a pedestrian. The driving assistance system may then warn the driver of a potential hazard or obstacle. Other aspects of driving assistance systems are described by Stein et al. (US2008/0036576, US2007/0024724, US2007/0221822, US2007/0115357), Stein (U.S. Pat. No. 7,113,867, U.S. Pat. No. 7,151,996), and Huang et al. (US2007/0152803).

Such devices require dedicated black boxes to be installed in the vehicle. Such devices are often too expensive for a typical driver driving a privately-owned vehicle. Therefore, such devices are mainly utilized by commercial entities managing large fleets of vehicles. No affordable solution exists that may enable a large fraction of drivers to install VEDR or driving assistance systems. Lacking unbiased evidence such as could be provided by VEDR, a typical accident investigation process is cumbersome and expensive. Also, existing systems for risk mitigation and improving driver behavior are limited to those vehicles with dedicated devices installed. In addition, existing systems are limited to monitoring the behavior of drivers of only the vehicles in which the systems are installed, and no other vehicles.

A modern cellular phone includes many of the hardware components required for standard VEDR functionality. For instance, some cellular phones include components with capabilities similar to those of a simple personal computer, e.g., random access memory (RAM), data storage media, CPU, graphics accelerator, and alphanumeric keypad. In addition, a cellular phone may include such components as motion sensors, GPS receiver, one or more video cameras, networking and Internet capability, remote component connectivity, high quality display, touch screen, battery, microphone, speakerphone, and other components. Systems for vehicle monitoring have been proposed which incorporate a cellular or other form of mobile phone. For example, US 2005/0230947 (Chen) describes a system that when air bags are inflated, indicating that an accident has occurred, a mobile phone photographs the interior of the scene and appropriate emergency services are notified. Hsu in US2002/0142727 describes a similar system. US 2008/0064446 (Camp et al.) describes a method in which some inherent capabilities of the mobile phone are employed in order to inhibit unsafe calling behavior by a driver. Plante in US2007/0219686 describes using a cellular network or other method to transmit event data to a remote server.

It is an object of the present invention to provide a system for vehicle monitoring and driver assistance that may be made available to any driver who has access to a handheld communication device such as a mobile phone.

Other aims and advantages of the present invention will become apparent after reading the present invention and reviewing the accompanying drawings.

### SUMMARY OF THE INVENTION

There is thus provided, in accordance with some embodiments of the present invention, a method of operating a general purpose handheld communication device to monitor traffic events. The handheld communication device is detachably mountable on a vehicle and includes a motion sensor, a video imaging sensor, a data processor, data storage medium, and data communication module. The method includes acquiring motion data using the motion sensor; identifying a traffic event based on the motion data; acquiring visual data using the video imaging sensor; saving data that includes the acquired visual data and motion data on the data storage medium; and communicating the saved data using the communication module.

Furthermore, in accordance with some embodiments of the present invention, the method further includes receiving a user request to acquire visual data, and acquiring visual data pursuant to said user request.

Furthermore, in accordance with some embodiments of the present invention, the method as claimed in claim 1, comprising video processing by the data processor, on the acquired visual data to identify and determine a license plate number.

Furthermore, in accordance with some embodiments of the present invention, the method includes comparing the determined license plate number with a database that includes a list of license plate numbers and issuing a video or audio alert when the determined license plate number matches a number that appears in the list.

Furthermore, in accordance with some embodiments of the present invention, the method includes video processing, using the data processor, of the acquired visual data to identify a hazardous or potentially hazardous traffic situation, and upon identification of such situation, issuing an audio or video alert.

Furthermore, in accordance with some embodiments of the present invention, the method includes determining whether the identified traffic event is a hazardous or potentially hazardous traffic situation, and upon identification of such situation issuing an audio or video alert.

Furthermore, in accordance with some embodiments of the present invention, the method includes requesting a user to provide identification data relating to an entity selected from a group of entities that includes vehicles and persons.

Furthermore, in accordance with some embodiments of the present invention, the method includes: providing a server adapted to communicate over a communication network, with the handheld communication device; storing on the server the saved data relating to the traffic event; assigning a score to an entity selected from a group of entities that includes vehicles and persons, the entity relating to the traffic event; and saving the score in a database that includes a list of scores of a plurality of entities.

Furthermore, in accordance with some embodiments of the present invention, the method includes verifying correct positioning and orientation of the handheld communication device when mounting on the vehicle, using visual indication on a display screen of the handheld communication device.

Furthermore, in accordance with some embodiments of the present invention, the method includes acquiring data from a proximity sensor, processing, using the data processor, acquired proximity data to identify a hazardous or potentially hazardous traffic situation, and upon identification of such situation, issuing an audio or video alert.

Furthermore, in accordance with some embodiments of the present invention, the method includes processing the acquired visual data or motion data using a technique selected from a group of techniques that includes: time stamping, attaching location data, encryption and access control.

Furthermore, in accordance with some embodiments of the present invention, the method includes communicating a notification of the traffic event to a predefined party.

Furthermore, in accordance with some embodiments of the present invention, the method includes displaying the saved data on a display screen of the handheld communication device.

Furthermore, in accordance with some embodiments of the present invention, there is provided a computer readable medium containing computer executable instructions, that when executed cause a data processor of a general purpose handheld communication device including a motion sensor, a video imaging sensor, the data processor, data storage medium, and data communication module to carry out the steps of:

acquiring motion data using the motion sensor, and identifying a traffic event based on the motion data;

acquiring visual data using the video imaging sensor;

saving data that includes the acquired visual data and motion data on the data storage medium; and

communicating the saved data to another device using the communication module.

Furthermore, in accordance with some embodiments of the present invention, the instructions further comprise instructions for: receiving a user request to acquire visual data, acquiring visual data pursuant to said user request and saving the visual data on the data storage medium.

Furthermore, in accordance with some embodiments of the present invention, the instructions further comprise instructions for: video processing by the data processor, on the acquired visual data to identify and determine a license plate number.

Furthermore, in accordance with some embodiments of the present invention, the instructions further comprise instructions for: comparing the determined license plate number with a database that includes a list of license plate numbers and issuing a video or audio alert when the determined license plate number matches a number that appears in the list.

Furthermore, in accordance with some embodiments of the present invention, the instructions further comprise instructions for: video processing, using the data processor, of the acquired visual data to identify a hazardous or potentially hazardous traffic situation, and upon identification of such situation, issuing an audio or video alert.

Furthermore, in accordance with some embodiments of the present invention, the instructions further comprise instructions for: determining whether the identified traffic event is a hazardous or potentially hazardous traffic situation, and upon identification of such situation issuing an audio or video alert.

Furthermore, in accordance with some embodiments of the present invention, the instructions further comprise instructions for: requesting a user to provide identification data relating to an entity selected from a group of entities that includes vehicles and persons.

Furthermore, in accordance with some embodiments of the present invention, the instructions further comprise instructions for: verifying correct positioning and orientation of the handheld communication device when mounting on the vehicle, using visual indication on a display screen of the handheld communication device.

Furthermore, in accordance with some embodiments of the present invention, the instructions further comprise instructions for: acquiring data from a proximity sensor, processing, using the data processor, acquired proximity data to identify a hazardous or potentially hazardous traffic situation, and upon identification of such situation, issuing an audio or video alert.

Furthermore, in accordance with some embodiments of the present invention, the instructions further comprise instructions for: processing the acquired visual data or motion data using a technique selected from a group of techniques that includes: time stamping, attaching location data, encryption and access control.

Furthermore, in accordance with some embodiments of the present invention, the instructions further comprise instructions for: communicating a notification of the traffic event to a predefined party.

Furthermore, in accordance with some embodiments of the present invention, the instructions further comprise instructions for: displaying the saved data on a display screen of the handheld communication device.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1A is a schematic diagram of a vehicle with an installed mobile phone cooperating with a handheld device based vehicle monitoring and driver assistance system in accordance with embodiments of the present invention.

FIG. 1B shows an enlarged view of the front and back of the mobile phone shown in FIG. 1A.

FIG. 2 is a block diagram of a handheld device based vehicle monitoring and driver assistance system, in accordance with embodiments of the present invention.

FIG. 3 is a flowchart of a method of operation of a member system of a handheld device based vehicle monitoring and driver assistance system, in accordance with embodiments of the present invention.

FIG. 4 is a flow chart of a driver rating method of a handheld device based vehicle monitoring and driver assistance system, in accordance with embodiments of the present invention.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the invention may include an article such as a computer or processor readable medium, or a computer or processor storage medium, such as for example a memory, a disk drive, or a USB flash memory, including encoding or storing instructions, e.g., computer-executable instructions, which when executed by a processor or controller, carry out methods disclosed herein

A handheld device based vehicle monitoring and driver assistance system in accordance with embodiments of the present invention includes one or more member systems. Each member system includes a handheld communication device, such as a mobile phone, that has been programmed with member system application software. The member system application software may enable the member system to monitor a vehicle in which the handheld communication device is mounted. In addition, the member system application software may enable the member system to provide driver assistance Whenever, in this description, the term “vehicle monitoring system” is used, it should be understood as referring to a vehicle monitoring and driver assistance system. The vehicle monitoring system may include one or more system servers or central computers that may communicate with the member systems. The member systems may communicate with the system server over a mobile phone network, or other network that enables communication between a handheld communication device and the system server. Alternatively, the handheld communication device of a member system may communicate with a computer that in turn communicates with the system server via the Internet or other communications network or method. In general, each handheld communication device may be associated with a driver or other individual, designated in this description as a “member driver,” who subscribes to the vehicle monitoring system. The handheld communication device may be installed or mounted in a vehicle, referred to as a “member vehicle.” A handheld communication device associated with a member system has at least one video imaging sensor, such as a camera, data storage medium, memory, a CPU, motion sensor, and possibly additional sensors and capabilities. The video imaging sensor may acquire video image data, or may record a sequence of still image data.

As used in this description, “handheld communication device” may refer to a general purpose handheld communication device, such as, for example, mobile telephone, cellular phone, pager, communicator, electronic organizer, personal digital assistant, smartphone, portable communications apparatus, or any other portable communications device. “handheld communication device” may also refer to a multimedia device or a navigation device, such as a GPS device A device that does not incorporate a camera or other component of a member system may be configured to communicate with an external camera or component. In this manner, a variety of devices may be configured to provide all of the functionality utilized by the system. A handheld communication device that is configured and activated for use with the vehicle monitoring system is referred to in this description as a “member system.” “Vehicle” may refer to an automobile, truck, bus, motorcycle, or any other vehicle.

The handheld communication device of a member system is programmed with member system application software or program. The application software may be configured for a particular combination of handheld communication device and member vehicle. The configuration may be fixed, or may be adjusted whenever the application software is activated. The member system application software is provided by the system server, or by a system administrator who operates the vehicle monitoring system, or by a separate vendor. For example, the system server may transmit the software directly to a member system handheld communication device, or may provide a suitable data storage medium from which the software may be loaded to a particular handheld communication device. Alternatively, the member application software may be separately provided, for example by a handheld communication service provider, or other vendors. Alternatively, the member application software may be integral to the handheld communication device. The member system application software may be incorporated into a memory or data storage device, or a processor, associated with the handheld communications device. The functionality of the member system application software program may be incorporated into a hardware component of the handheld communication device.

When installed in a vehicle, and when the member system application is operating, the member system collects data from a camera and other sensors that are incorporated in the handheld communication device, as well as any other sensors or data sources with which it may communicate. The collected data is analyzed for the purpose of detecting a traffic event. Traffic events may include such circumstances as collisions, near collisions, unsafe driving, or any other predefined set of circumstances. A traffic event may be detected automatically from analysis of camera or sensor data, or may be signaled by a member driver or other person with access to the member system. Data associated with a traffic event is stored in the member system, and may be sent to the system server or transferred to a computer. In addition, the vehicle monitoring system may provide assistance to the driver.

Prior to operating a vehicle, a member driver mounts the programmed handheld communication device at a location inside the passenger compartment of the vehicle. The location may be on or near the dashboard or windshield of the vehicle. A handheld communication device holder on which the handheld communication device may be mounted may be provided by the system administrator. In regions where membership in the vehicle monitoring system is widespread, the handheld communication device holder may be installed or provided by a vehicle dealer or manufacturer. The handheld communication device holder may be designed for a particular handheld communication device design, or may be adaptable to several designs. The handheld communication device holder and vehicle monitoring system application may be configured to disable hands-on use of the phone while driving. In such cases, using the phone without hands, for example by using Bluetooth accessories or a speakerphone, may still be enabled.

The handheld communication device is mounted such that a camera of the phone views an external viewing region or scene in front of the vehicle through the windshield. If the handheld communication device includes a second camera, the second camera may be oriented so as to view a viewing region or scene interior to the vehicle. The viewed interior scene may preferably include the driver. The viewed interior scene may include some of the vehicle instruments. When the viewed interior scene is to include vehicle instruments, a system of mirrors, or other optical system may be provided for redirecting all or part of the camera's field of view toward the instruments. Such an optical system may be included in, for example, the handheld communication device holder. Alternatively, the field of second camera may be directed toward a side of the vehicle, or at any other suitable scene. Similarly, when the handheld communication device includes one camera only, an optical system may be provided such that part of the camera's field of view is directed toward the interior of the vehicle or at another scene.

When the handheld communication device is mounted in the handheld communication device holder, the member system software application may be activated. Activation may be performed automatically upon mounting in the handheld communication device holder, or by voice command, by pressing one or more buttons or otherwise activating a control on the handheld communication device, by connecting the handheld communication device to a charger, or any other predetermined action. Activation of the application may include identifying one or more entities, such as the vehicle in which the handheld communication device is currently installed, or a driver or user. If several drivers share a handheld communication device, or if the owner of the handheld communication device is riding as a passenger, activation may also include identifying the driver or other user. Identifying a driver or user may include entering a password or other identifying data, such as, for example, a photograph, electronic signature, fingerprint, or other biometric identification, of the driver or user. Activation may also include connecting or turning on any auxiliary devices associated with the member system.

If necessary, the member system application may issue audible or displayed instructions for adjusting the orientation, location, or placement of the handheld communication device in order to optimize the exterior and interior views. The member system application may determine the quality of the current view using known image processing techniques for recognizing, and determining the relative locations of, predetermined objects. Such objects may include the hood of the vehicle, the steering wheel, the head or eyes of the driver, or any other appropriate object. Use may also be made of orientation sensors, such as accelerometers, that are incorporated into the handheld communication device or handheld communication device holder in order to sense the orientation of the handheld communication device. Alternatively, the member system software application may provide aids to assist a user in adjusting the placement of the handheld communication device. For example, the display of the handheld communication device may superimpose one or more marks, such as lines or arrows, on an image acquired by a camera of the handheld communication device. The phone is then adjusted until the marks coincide with predetermined features in the image, such as the front of the hood, a hood ornament, a road dividing line, or any other suitable feature. By following the issued instructions, the user may adjust the handheld communication device, a handheld communication device holder, a mirror, or any other adjustable component, in order to optimize the views. Alternatively, the handheld communication device holder may be provided with one or more motorized actuators for adjusting the orientation of the handheld communication device. In this case, the vehicle monitoring system application automatically operates the motorized actuators in order to adjust the orientation of the handheld communication device.

The first time that the member system software application is activated in a specific vehicle, or if the orientation of the handheld communication device holder was changed, it may be necessary to perform an adjustment procedure to determine the optimum orientation in that vehicle.

Once the member system software has been activated and the orientation of the phone adjusted, the member system operates fully automatically. The member system continuously acquires video images from the handheld communication device cameras, including an external view, and, possibly, an interior view. The member system may continuously acquire additional data from the various sensors included in the handheld communication device. Such sensors may include, for example, microphone, GPS receiver, and motion sensors such as accelerometers, tilt sensors, or other inertial sensors. Sensors may also include a radio-frequency identification (RFID) identification sensor, or any other type of proximity sensor. The member system may also receive data communicated to the member system by a system server.

The member system application or driver may configure the member system either to display or not display acquired image and other data in real time. For example, during the adjustment of phone orientation, displaying the data may provide useful visual feedback. However, during driving, especially at night, displaying image or other data routinely may be distracting. In addition, displaying data in real time may consume resources that could otherwise be used to process the acquired data. The member system may be configured to display only certain data that provide driver assistance, such as warnings or images of traffic signs or potential hazards.

Alternatively, in addition to capabilities inherent to, or associated with, the handheld communication device, the vehicle monitoring system may enable connectivity to vehicle systems present in the monitored vehicle. Such connection may be provided, for example, through a handheld communication device adapted for this connection. The vehicle systems of the monitored vehicle may include displays, speakers, vehicle computers, vehicle event data recorder, radar, electronic control units, air bag activators, range finders, or other built-in devices. Such connectivity may enable data exchange between the vehicle monitoring system and the monitored vehicle. Additional data may thus be acquired from the monitored vehicle. Additional devices, not built into either handheld communication device or the monitored vehicle may be connected to the member system. For example, video cameras may be added to vehicle to observe the sides and rear of the monitored vehicle.

Data acquired from such sensors may include, for example, sounds that are audible inside the vehicle, time and date, speed, acceleration, and location of the vehicle. Acquired data is recorded and stored in temporary memory buffers. The temporary memory buffers generally are located on a storage medium, such as a flash device, or other non-volatile memory, associated with the handheld communication device. Acquired data may also be stored in parallel on RAM associated with the handheld communication device. The member system performs various processing algorithms on the data being acquired. The processing algorithms are designed to detect exceptional occurrences, referred to as “traffic events.” During routine driving conditions, when no traffic events occur, the content of the temporary memory buffers is continuously overwritten or replaced by new data as it is acquired. However, when a traffic event occurs, data that was acquired during a predetermined period prior to, during, and after the traffic event may be copied to permanent memory. Permanent memory is located at a location on a data storage device associated with the handheld communication device. Data stored at the permanent location is not overwritten or erased automatically. Such data, or the results of processing such data, may also be sent by the member system to a central processing or storage device associated with a system server, or to other member systems.

The length of the predetermined period prior to, during, and after the traffic event for which data is permanently saved may be determined by member system application software, or may be configurable by a user. A typical length of the time period may range from a few seconds to a few minutes. The length of the time period may be determined on the basis of the nature of the traffic event, available data storage space, or other relevant considerations. Recording and saving the traffic event data may be accompanied by an audible or visible signal that indicates that a traffic event has occurred and that traffic event data is being recorded and saved.

A vehicle monitoring system in accordance with embodiments of the present invention may provide several methods of determining when a traffic event occurs, and when data is to be permanently recorded. For example, the member system may automatically identify a traffic event on the basis of acquired data. For example, processing data acquired from a handheld communication device GPS receiver, motion sensor, accelerometer, proximity sensor, or video image data may indicate one or more exceptional conditions. Such conditions may include, for example, exceptional acceleration consistent with hard braking, swerving, bumpy road conditions, or a collision. Such conditions may also include an exceptional tilt angle indicating an overturned vehicle, excessive vehicle speed or other disregard for traffic signals or signs, the approach of another vehicle in a possibly unsafe manner, or other conditions indicative of problematic vehicle handling or traffic conditions

The member system may also respond to a user request to save data as a traffic event. For example, the member system may enable a member driver or other user to indicate that a traffic event has occurred and that data is to be permanently saved. For example, a member driver may observe an exceptional situation. Such an exceptional situation may include, for example, an accident involving the driver's own vehicle or other vehicles, another vehicle moving in a dangerous manner, heavy or jammed traffic, or a crime being committed. The member driver may indicate occurrence of the traffic or other event and trigger traffic event recording by, for example, a voice command, by pressing a button on the handheld communication device, by triggering a device that communicates with the phone such as a Bluetooth device, or any other method of signaling or operating a handheld communication device. Recording of traffic event data may end automatically after a predetermined time interval has elapsed, or the user may signal the end of the traffic event in a predetermined manner.

The traffic event data may be permanently saved locally on a data storage device associated with the handheld communication device. The data may be encrypted prior to saving. A personal password may be associated with the driver or user of the member system that may be used in encrypting and decrypting the data. The saved traffic event data may be processed by the member system on a processing unit associated with the handheld communication device. Alternatively, or in addition, traffic event data may be uploaded or transferred to a vehicle monitoring system server, or other central computer or data storage unit, provided by the system administrator. Data may be transferred using a connectivity function, technology, or protocol associated with the handheld communication device. Such technologies and protocols may include, for example, 3G, 4G, Wi-Fi, WiMAX, LTE, Bluetooth, WLAN, GPRS, GSM, HSCSD, HSDPA, UMTS, W-CDMA, or WiDEN. The stored or transferred data may be time stamped, or stamped with other identifying data, and saved in both a raw data format and an encrypted data format. By means of the encryption, the stored data may be protected from tampering, or detection of tampering may be facilitated. Time stamping, encryption, and saving in the raw data format may increase usefulness of the stored data as legal evidence. The driver or user of the member system may be provided with the ability to control access to some or all of the data. For example, the user may be able to control access to images and audio recordings of the passenger compartment of the vehicle, or other data that may lead to an invasion of the user's privacy Access to other types of data, for example deceleration and speed, may be controlled by a system administrator.

Transferring the data to a system server may enable examination of the data by processing software or by appropriate authorized personnel. Such personnel may include, for example, insurance company representatives, accident analysis experts, driving instructors, or law enforcement personnel. Examination of the data may enable, for example, objective determination of the cause of an accident, or objective evaluation of the performance of a driver. Investigation results may be used, for example, to fairly distribute the cost of an accident among the parties involved or to adjust insurance premiums. Analysis results regarding driver performance may be forwarded to the driver as configurable feedback, or may be used to determine a course of instruction in order to improve the driver's skills. Continuous and timely feedback from the vehicle monitoring system may contribute to continuous improvement of the driver's driving skills.

In accordance with embodiments of the present invention, a database manager system associated with the vehicle monitoring system server may manage a database of recorded traffic events and driving behavior. The database manager system may rate member drivers by assigning scores or points. The assigned scores are assigned such as to reflect the quality of the driving behavior or the driver. The assigned scores may be affected by the number and the nature of recorded traffic events in which the member driver was involved. For example, the score may be assigned in such a manner that when a member driver drives carelessly or causes an accident, the member driver's score may be lowered. When a member driver contributes to road safety by the reporting unsafe driving by another driver or unsafe road conditions, the member driver's score may be raised. The score may affect the premium that a member driver pays to an insurance company who is, or cooperates with, the system administrator of the vehicle monitoring system. The score may also affect the eligibility for renewal of the member driver's driving license by a licensing authority that either is, or cooperates with, the system administrator of the vehicle monitoring system. Alternatively, on the basis of the member driver's score, an authority may decide whether the member driver is required to take, or is exempt from, a driver safety course.

The vehicle monitoring system may also rate a driver or vehicle that is not a member of the vehicle monitoring system. For example, a member system installed in a member vehicle may acquire an image of a nonmember vehicle using a handheld communication device camera that is viewing the region in front of the member vehicle. A person in the member vehicle indicates to the vehicle monitoring system, or processing software automatically detects, that the nonmember vehicle is, for example, moving in an unsafe manner. The acquired image of the nonmember vehicle may include the license plate of the nonmember vehicle. Image analysis algorithms for extracting a license plate number from an image of a license plate are known. The vehicle monitoring system may then use such a license plate number extraction algorithm to determine the license plate number of the nonmember vehicle. The database manager system may then add the traffic event data, and the license plate number of the nonmember vehicle, to the database of recorded traffic events. Alternatively to extracting a license plate number, the system may identify another vehicle or driver may by means of RFID or other proximity sensor. In this manner, the database manager system may also include scores for drivers or vehicles that are not members of the vehicle monitoring system. A cooperating authority may then, for example, report the scores of nonmember drivers to the nonmember driver's insurance company, or to another authority. The ability of member drivers to report the unsafe driving of nonmember drivers, and nonmember drivers' knowledge of this ability, may influence careless drivers in an area where the vehicle monitoring system exists to drive more carefully. Similarly, a member driver cannot avoid detection of the member driver's own unsafe driving by simply not activating the member system application software. In this manner, a vehicle monitoring system in accordance with embodiments of the present invention may contribute to a decrease in the local accidence rate and a reduction in losses to insurance companies.

Since a vehicle monitoring system in accordance with the present invention uses handheld communication device components to acquire data, use of the system need not be limited to a person in a vehicle. For example, a member driver who is currently a pedestrian may use a handheld communication device to access the vehicle monitoring system to indicate the occurrence of an traffic event and to trigger traffic event recording. For example, a traffic event observed by a pedestrian may include a vehicle parked illegally, a malfunctioning traffic signal, abnormal road conditions, or abnormal traffic conditions.

An authority that is not the system administrator of the vehicle monitoring system, for example an insurance company, government, or police force, may receive data regarding an traffic event. Such access may be contingent on permission being granted by the system administrator or by a driver involved in the traffic event. A party that is not the system administrator may subscribe to the vehicle monitoring system for the purpose of receiving relevant data, subject to any relevant access permissions. For example, a company that manages a vehicle fleet may not be a member of a particular vehicle monitoring system. However, by subscribing to the vehicle monitoring system, the fleet managing company may receive reported data regarding traffic events involving vehicles in the fleet. Several vehicle monitoring systems operating in a single geographical area, or in neighboring geographical areas, may cooperate by subscribing to one another.

The wide availability of mobile phones and other handheld communication devices may enable a wide membership to the vehicle monitoring systems operating in a geographic region, facilitating the collection of driving related statistics. Building a road safety network of one or more vehicle monitoring systems, subscribers, and cooperating bodies, may improve traffic safety in a geographical region. A system administrator, in cooperation with such a road safety network, may perform or sponsor such activities as distributing images of accidents and near accidents for the purpose of safety education, conduct discussion forums, increasing community involvement in assignment of scores, or other activities designed to increase safety awareness in a community.

In addition to reporting traffic events, a member system may process acquired data as it is acquired. The acquired data is analyzed and assistance is provided to the member driver on the basis of the results of the analysis. For example, by analyzing images of the road ahead acquired by the handheld communication device camera, the member system may detect, and warn the member driver of potentially dangerous circumstances. For example, if analysis shows that the distance to a vehicle ahead is decreasing rapidly, the vehicle monitoring system may warn the member driver of a possible collision. The warning may be in the form of an audible signal or message generated by a speaker associated with the handheld communication device. The audible signal may be accompanied by a text or symbolic warning that is displayed on a display associated with the handheld communication device. Other examples of situations that may be detected by the vehicle monitoring system, resulting in the generation of a warning, may include departure from a traffic lane, the presence of a vehicle in a blind spot, the presence of a warning sign (e.g. bump, pedestrian crossing, school zone, or similar warning signs), rapid approach of such hazards as a curve in the road, pedestrian, traffic signal, intersection, railroad crossing, or other potential hazard. The vehicle monitoring system may also detect, and warn regarding, driving behavior that may indicate a problem with the driver or vehicle. For example, swerving, erratic steering, acceleration or braking, or a vehicle speed inconsistent with local legal limits or road conditions, may indicate that the driver is drowsy, distracted, or inattentive, or may indicate a problem with the vehicle.

The vehicle monitoring system may also extract license plate number data as an image of the license plate of a vehicle is acquired. The extracted license plate number may then be compared with a list of license plate numbers belonging to vehicles that had been associated by the database manager system with unsafe driving. An updated list of potentially unsafely driven vehicles may be downloaded to a memory associated with the handheld communication device whenever the member system software application is activated. Alternatively, the comparison may be carried out by communication with the database manager system. If the extracted license plate number is associated with unsafe driving, the member system may issue an appropriate cautionary warning. The warning may be tailored to specific unsafe behavior associated with the vehicle. For example, if the extracted license plate number is associated with sudden stops, the warning may advise the member driver to increase the length of the driving interval between vehicles.

The member system may use an RFID or other proximity sensor to identify potential hazards. For example, the system may detect by means of a proximity sensor that another vehicle is too close, indicative of tailgating. As another example, a proximity sensor may detect the approach to a tagged road sign.

The vehicle monitoring system may assist the member driver in other ways. For example, the current location of the vehicle as derived from a GPS receiver associated with the handheld communication device may be reported directly to appropriate emergency services if an accident is detected. In addition, video data may be provided to the emergency services. Information useful to the emergency services, such as the severity of the accident or the number of vehicles or people involved, may be extracted from the video data. If a traffic event, such as an accident, is detected that may lead to the disruption of traffic, the vehicle monitoring system may send a message warning of the disruption in traffic to member drivers who are traveling in the vicinity. In addition, when a traffic event is detected, a notification message may be sent to a predefined party. For example, in a case of teenaged driver, a notification message may be sent to the driver's parents. If the member vehicle is part of a fleet or belongs to a rental company, an appropriate supervisor may be notified.

The vehicle monitoring system may provide information to the member driver. The purpose of providing the information is to assist in improving the member driver's driving skills. For example, real time warnings while driving may alert the member driver to bad driving habits. Electronic or hardcopy reports may be delivered periodically to the member driver. A report may include video, audio, or textual information describing a traffic event and the analysis of the traffic event. An electronic report may be in a standard electronic file format, or may be in a special format that may be reviewed using dedicated software. An electronic report may be sent to the handheld communication device of the member system, or to any computer. A report may indicate patterns in member driver's driving habits. Such patterns may be detected by analysis software associated with the database manager system. For example, such a report may indicate that the member driver drives poorly at night or during rainy weather. Such a report may also allow evaluation of the member driver's driving relative to that of other drivers. The report may include advice for improved driving. In addition, the report may also include information and advice regarding driving habits that may contribute to excessive fuel consumption or excessive wear of the vehicle. The member driver may, for example, be instructed to access an Internet site associated with the vehicle monitoring system for the purpose of receiving personalized instruction toward improved driving habits.

Reference is now made to the figures.

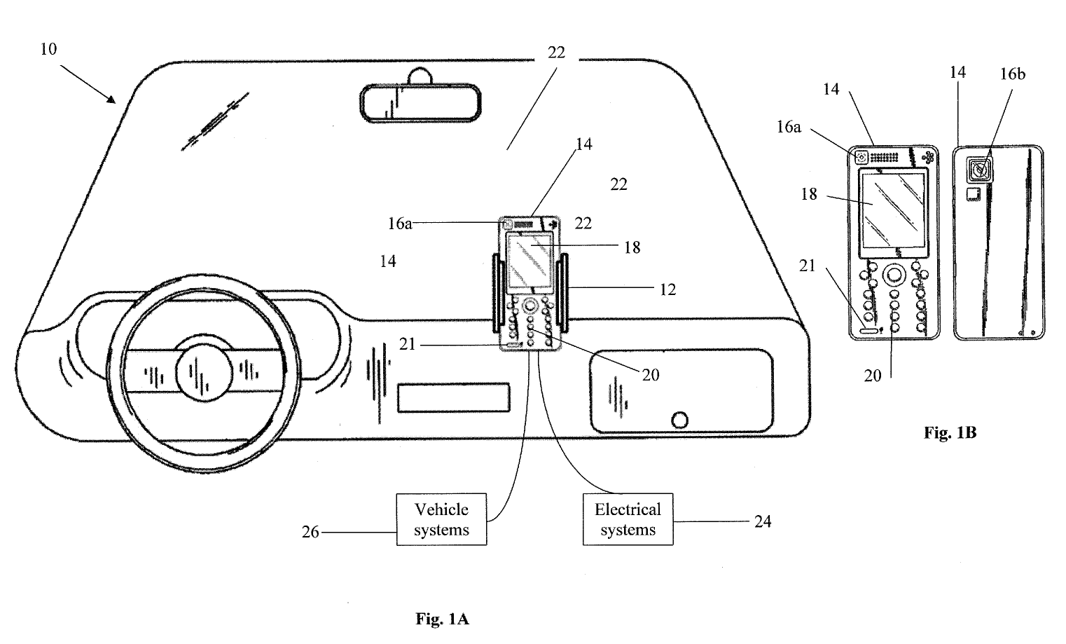

FIG. 1A is a schematic diagram of a mobile telephone that is connected to a handheld device based vehicle monitoring and driver assistance system in accordance with embodiments of the present invention. FIG. 1B shows an enlarged view of the front and back of the mobile phone shown in FIG. 1A. Device holder 12 is placed in or mounted on vehicle 10. Device holder 12 is placed near the front portion of the passenger compartment of vehicle 10, near windshield 22. A handheld communication device, such as mobile phone 14 may be inserted into and held by device holder 12. Mobile phone 14 is programmed with vehicle monitoring system software that enables mobile phone 14 to serve as part of a vehicle monitoring system. Device holder 12 may be connected to the electrical system 24 of vehicle 10. The connection to electrical system 24 may provide electrical power to mobile phone 14. Device holder 12 may also be connected by wired or wireless connection to one or more vehicle systems 26. The connection to vehicle systems 26 may enable mobile phone 14 to communicate with vehicle systems 26. Mobile phone 14 includes at least one video imaging sensor, such as front camera 16a and rear camera 16b. At least one video imaging sensor, in this case rear camera 16b, is aimed so as to view a scene in front of vehicle 10 through windshield 22. Device holder 12 is configured to aim camera 16b at a predetermined scene outside vehicle 10. Device holder 12 may also be configured to aim camera 16 at a predetermined scene outside inside vehicle 10. Device holder 12 may be adjustable so as to ensure that cameras 16a and 16b view the predetermined scenes. Display screen 18 may display visual information provided by the vehicle monitoring system. Information and commands may be input to the vehicle monitoring system by means of keypad 20, microphone 21, and vehicle devices 26.

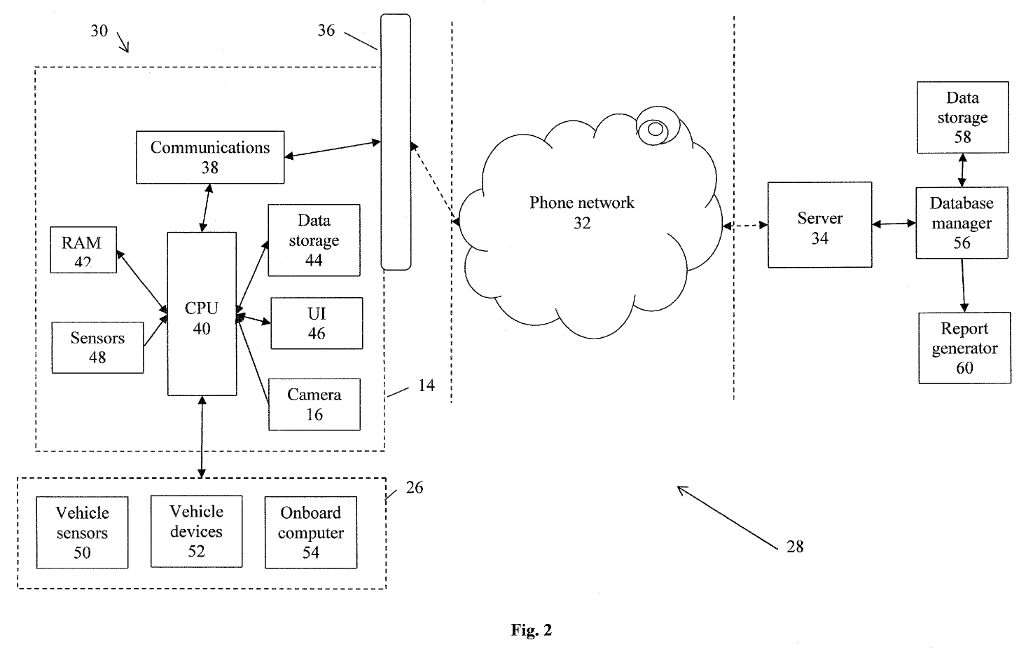

FIG. 2 is a block diagram of a handheld device based vehicle monitoring and driver assistance system, in accordance with embodiments of the present invention. Vehicle monitoring system 28 includes one or more vehicle based member systems 30. In general, each member system 30 is located in a separate vehicle. Each member system 30 communicates with system server 34 via phone network 32.

A member system 30 includes a handheld communication device, such as mobile phone 14. Component modules of mobile phone 14 provide part of the functionality of member system 30. For example, mobile phone 14 may communicate with mobile phone network 32 via communications module 38 and antenna 36. Communications module 38 communicates with CPU 40. CPU 40 may communicate with a user, such as a member driver, via various input and output devices, illustrated collectively as user interface 46. User interface 46 may include devices built into mobile phone 14, such as a display, speaker, microphone, or keypad. User interface 46 may also include devices that are external to mobile phone 14, but which communicate with mobile phone 14 by means of wires, connectors, or wireless interfaces. CPU 40 may receive image data from one or more cameras 16, and other data from one or more built in sensors 48. CPU 40 may encrypt or process received data in accordance with programmed instructions, and with access to phone memory 42. Received data may be stored temporarily (for example, until replaced with newer data) in temporary data buffers on storage media 44. Data may be permanently stored on one or more storage media 44. CPU 40 may also communicate with vehicle systems 26. For example, CPU 40 may receive data from vehicle sensors 50, and may communicate with one or more vehicle onboard computers 54. CPU 40 may communicate with a user by means of vehicle input/output devices 52. Vehicle input/output accessories may include, for example, displays, speakers, data ports or cables, and wireless connections such as Bluetooth accessories.

Member system 30 may send acquired data to system server 34 via phone network 32. The circumstances under which member system 30 sends data to system server 34 are determined by system application software that runs on CPU 40. System server 34 may cause the system application software, or data files accessed by the system application software to be updated or modified. The software or files may be updated or modified by means of appropriate instructions and data sent by system server 34 to member system 30.

System server 34 may receive data sent from a member system 30. In general, the received data includes information identifying the member system that sent the data. System server 34 communicates with database manager 56. System server 34 may send received data to database manager 56. Database manager 56 may attach an appropriate label or timestamp to the received data and store the data in data storage facility 58. Database manager 56 may process the received data. Such processing of the data may include encryption of the data to aid in preventing or detecting tampered data. Processing may also include assigning access restrictions to data, possibly password protected. Processing may include analysis of the data. Analysis results may be sent to one or more member systems 30. Analysis results may also be stored in data storage facility 58.

Database manager 56 may send data to report generator 60. Data may be sent to report generator 60 when required by a software application running on database manager 56. Data may be sent to report generator 60, for example, as a result of data analysis performed by database manager 56, or at predetermined times. Report generator 60 may compile data into a suitable report format. The compiled report may then be sent to an appropriate party, including one or more member systems, contingent on obtaining any required access permissions.

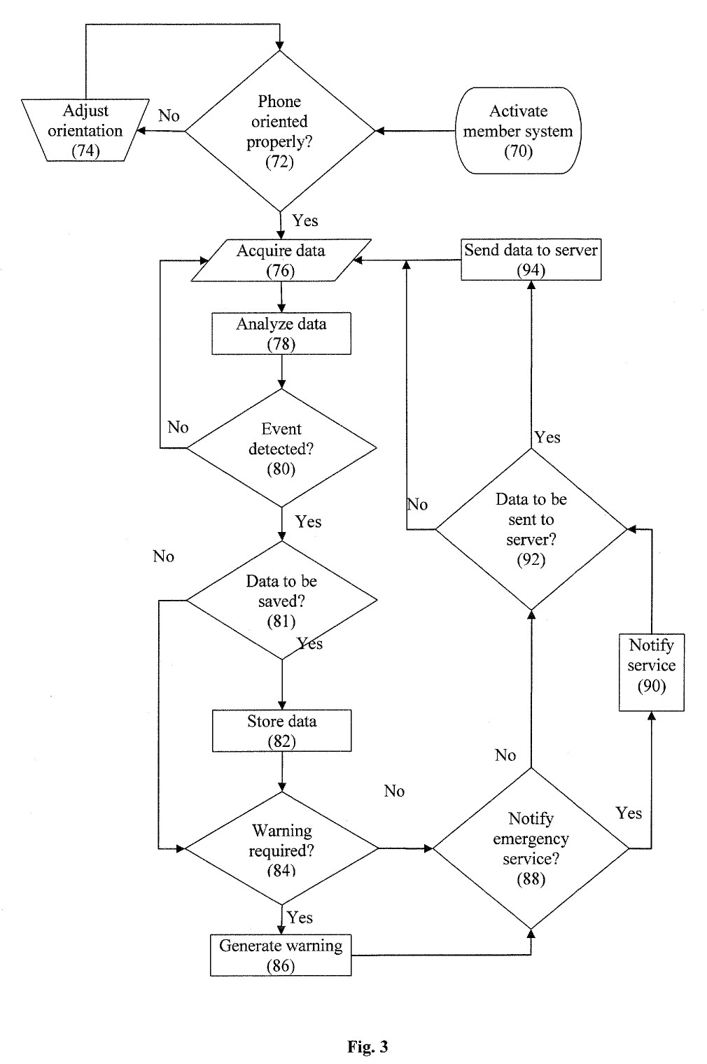

FIG. 3 is a flowchart of a method of operation of a member system of a handheld device based vehicle monitoring and driver assistance system, in accordance with embodiments of the present invention. It should be understood that the order of steps in the flow chart is for illustration purposes only. A person skilled in the art will understand that the order of some of the illustrated steps may be modified without affecting the results of the method. It should be further understood that the grouping of the various components of the method into discrete steps is for illustration purposes only. A person skilled in the art will understand that the method may be distributed differently into discrete steps without affecting the results of the method. Furthermore, steps may have been omitted from the flow chart for purposes of clarity. It should be understood that all such variations are to be considered as falling within the scope of embodiments of the present invention.

A member driver or other user of the system mounts a mobile phone that has been programmed with the member system application software on a mobile phone holder in the vehicle. Mounting the mobile phone on the mobile phone holder may initiate the software application. Alternatively, the user initiates the software application, for example, by voice command, manually, or connecting to a structure of the mobile phone holder (step 70). The vehicle monitoring system application may acquire and analyze an image to determine whether the mobile phone is positioned and oriented as required on the mobile phone holder (step 72). Alternatively, the vehicle monitoring system application may instruct the user how to determine whether the mobile phone is oriented properly. If the orientation is not optimal, the vehicle monitoring system application instructs the user how to optimize the orientation (step 74). Alternatively, the vehicle monitoring system application may cause a motorized mobile phone holder to automatically adjust the orientation of the mobile phone.

The member system then proceeds to acquire data (step 76). Data may be acquired from various cameras and sensors of the mobile phone, or from sensors that communicate with the mobile phone. Sensors data may include accelerometer data, GPS signals, image data, and data from vehicle monitoring systems. The acquired data is time stamped and stored temporarily in a temporary buffer on a mobile phone storage device. The data is then analyzed in the mobile phone CPU using the vehicle monitoring system application software (step 78). For example, the analysis may compare features of the acquired data with predefined features that characterize a traffic event. When sufficient features of the data match features that characterize a traffic event, the traffic event is detected (step 80). For example, very high deceleration may indicate a collision event. As another example, analysis of vehicle speed data (acquired, for example, from GPS data or vehicle speed sensors) together with location data (acquired from a GPS sensor), may indicate that the vehicle is traveling above a posted speed limit. As another example, analysis of image data may indicate that another vehicle previously associated with unsafe driving is in front of the vehicle in which the member system is installed. As another example, an action performed by a person in the vehicle, for example a spoken signal or manual activation of a device that communicates with the mobile phone, may indicate that the person wishes to report an observed traffic event.

Depending on the nature of the detected traffic event, data associated with the detected traffic event may be permanently stored on a storage medium (step 81). For example, data associated with detection of a vehicle previously associated with unsafe driving may not be permanently stored. On the other hand, data associated with hard braking or a collision may be permanently stored. When traffic event data is to be permanently stored, the data that was temporarily stored in the temporary buffer during a predetermined period prior to the traffic event detection is transferred to a permanent storage location (step 82). In addition, data that is acquired during a predetermined period after the traffic event detection is stored in permanent storage. When no traffic event is detected, the member system continues to acquire and analyze data.

Depending on the type of traffic event, the member system may issue a warning to the driver of the vehicle. In general, traffic events that result in a warning are traffic events that indicate that the driver is required to perform a preventative action, to exercise caution, or to drive more carefully. The member system checks whether the detected traffic event corresponds to a traffic event that requires a warning (step 84). If so, the member system generates a warning (step 86). A warning generally includes an audible signal that indicates to the driver that the driver's attention is required. The audible signal may be produced by a speaker of the mobile phone, or a speaker associated with the vehicle. The audible signal, or a visible signal displayed concurrently, may also indicate to the driver the nature of the traffic event and the action to be taken.

The member system then determines if notification of one or more emergency services is necessary (step 88). For example, if the detected traffic event corresponds to an accident, it may be necessary to notify an ambulance service and the police. In the case of other traffic events, such as observation of a crime in progress or a fire, it may be necessary to notify the police or fire department. The member system then notifies the appropriate emergency service (step 88). The notification may be routed via the system server, where personnel monitoring the vehicle monitoring system may be notified to monitor the progress of the traffic event. The notification to an emergency service may include information that could assist the service. Such information may include location data, and video images of the interior and exterior of the vehicle.

Some data from detected traffic events may be transferred from the member system to the system server. Such data may include detected unsafe driving or accidents, and observed unsafe driving or criminal activity. Depending on the nature of the detected traffic event, the data may be sent to the system server soon after the traffic event is detected, or at a later time. For example, for an accident traffic event, data may be sent to the system server immediately. However, data that does not require immediate action, for example observed or detected potentially unsafe driving, need not be sent to the system server immediately. In this case, the data may be sent at a later time, for example, after peak phone network hours. When the member system determines that it is time to send data to the system server (step 92), the data is sent (step 94). The member system then continues to acquire and analyze data.

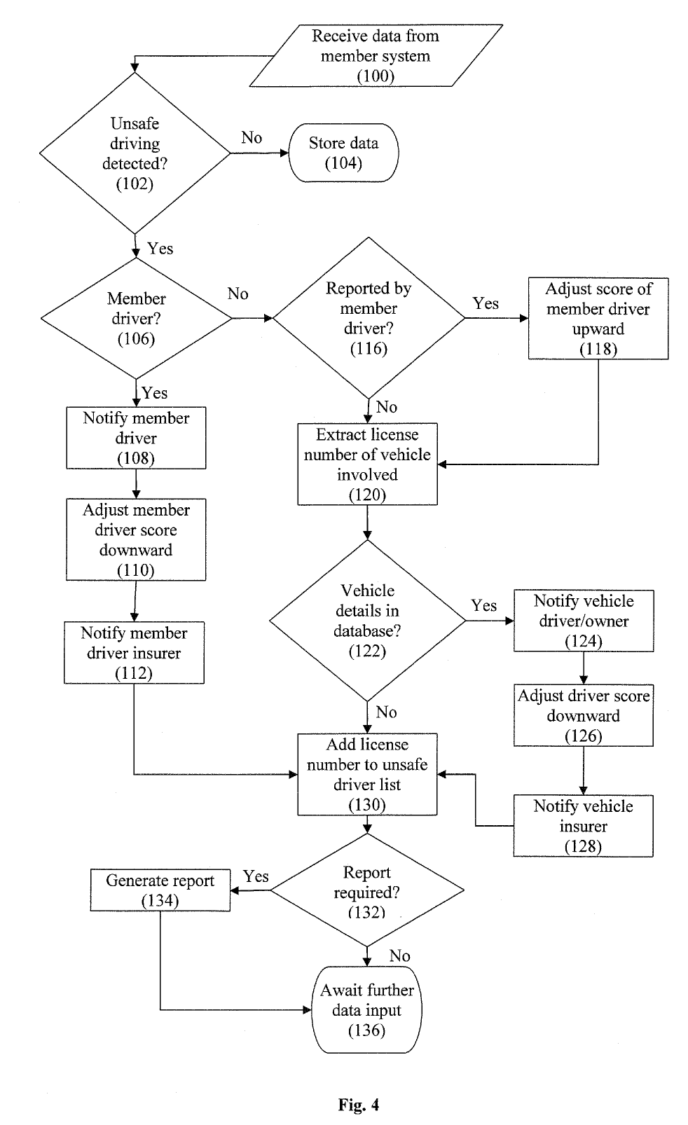

When data is sent to the system server, the data is transferred to the database manager for driver rating, and further analysis and processing. FIG. 4 is a flow chart of a driver rating method of a handheld device based vehicle monitoring and driver assistance system, in accordance with embodiments of the present invention. It should be understood that the order of steps in the flow chart is for illustration purposes only. A person skilled in the art will understand that the order of some of the illustrated steps may be modified without affecting the results of the method. It should be further understood that the grouping of the various components of the method into discrete steps is for illustration purposes only. A person skilled in the art will understand that the method may be distributed differently into discrete steps without affecting the results of the method. Furthermore, steps may have been omitted from the flow chart for purposes of clarity. It should be understood that all such variations are to be considered as falling within the scope of embodiments of the present invention.

When data is received from a member system (step 100), the received data is analyzed for indications of unsafe driving (step 102). If no unsafe driving is detected, the data is stored, and possibly subjected to further treatment (step 104). Such further treatment may include analysis for evidence of poor road or traffic conditions, analysis for evidence of a crime being committed, illegal parking, or other conditions requiring further reporting or analysis.

If unsafe driving is detected, the system determines whether or not the unsafe driving was the fault of the vehicle in which the member system that had sent the data is installed (step 106). In general, unsafe driving in the vehicle in which the member system is installed is detected automatically by the member system. If the unsafe driving was performed by a member driver, the member driver is notified of the unsafe driving, and of the possible effect on the member driver's rating (step 108). The notification may be sent via the mobile phone associated with the member system, or by other notification means. The member driver's rating is a score, or set of scores, that is stored by the vehicle monitoring system database manager, and is associated with the member driver. The values of the scores indicate the degree to which the member driver's driving conforms to safe driving practices. For the purpose of this discussion, a higher score or rating indicates a safe driving history, while a lower score or rating indicates a driving history that includes unsafe driving. The member driver's rating may be adjusted downward in accordance with the severity of the unsafe driving (step 110). The severity of the unsafe driving may be determined in relation to predetermined criteria. The criteria may include such considerations as expected potential seriousness of the consequences of the unsafe driving, and the previous driving history of the member driver. The adjustment in the member driver's rating may then be reported to the member driver's insurance company, or another appropriate agency, such as a fleet manager (step 112). Furthermore, the license number of the member driver's vehicle may be added to a list of potentially unsafely driven vehicles (step 130). The unsafely driven vehicles list is maintained by the database manager of the vehicle monitoring system for the purpose of cautioning other drivers who are in the vicinity of a vehicle on the list.

Unsafe driving by a driver who is not a member driver of the vehicle monitoring system may be automatically detected by the vehicle monitoring system, or may be reported by a member driver (step 116). In the event that the unsafe driving was reported by a member driver, a score of the member driver may be adjusted upward as acknowledgement that that member driver contributes to road safety (step 118). The system then extracts the license number of the vehicle that was driven unsafely from image data of the vehicle (step 120). The extracted license number is compared with a list of license numbers in the system database (step 122). Details of the driver or owner of the vehicle may exist in the database. For example, the vehicle may belong to a member driver, or details may have been provided by a company or authority that cooperates with the vehicle monitoring system. In this case, the driver or owner of the vehicle may be notified of the unsafe driving (step 124). The rating or score associated with the vehicle may be adjusted downward to reflect the unsafe driving (step 126). In addition, the vehicle or driver's insurance company, or other appropriate party, may be informed of the change in the score (step 128). Whether or not details associated with the license number exist in the database, the license number of the member driver's vehicle may be added to a list of potentially unsafely driven vehicles (step 130).

The database manager may issue reports under predetermined circumstances. Such circumstances may include, for example, detection of certain types of traffic events, changes in a driver's score, or addition of a license number to a list of unsafely driven vehicles. In addition, the database manager may be configured, for example, to issue periodic reports at predetermined times. If the circumstances indicate that a report is to be issued (step 132), the database manager of the vehicle monitoring system may generate a suitable report (step 134). For example, a report issued to an insurance company or traffic authority may include appropriate details of a detected traffic event, the driving history of a driver, results of the analysis of a single traffic event or driver, or data that summarizes detected patterns or trends in data accumulated with regard to a particular time period or geographic area. A report issued to a member driver or other driver may include instruction or coaching to improve the safety of the driver's driving, a recommendation or requirement to take a course in safe driving, or other appropriate data or instructions.

The database manager system then waits for further data input (step 136).

Thus, a handheld device based vehicle monitoring system in accordance with embodiments of the present invention provides a system that may be distributed to a large number of drivers in a region, that enables system users to report the activities of other drivers, and that communicates results in a timely fashion to the appropriate parties and authorities.

A handheld device based vehicle monitoring system in accordance with embodiments of the present invention may be appealing to a vehicle fleet manager, a privately or publicly owned company, an insurance company, a government department or authority, or any other private or public entity that may administrate a vehicle monitoring system.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A method of operating a general purpose handheld communication device to monitor traffic events, the handheld communication device being detachably mountable on a vehicle and including a motion sensor, a video imaging sensor, a data processor, data storage medium, and data communication module, the method comprising:
acquiring motion data using the motion sensor;
identifying a traffic event based on the motion data;
acquiring visual data using the video imaging sensor;
saving data that includes the acquired visual data and motion data on the data storage medium; and
communicating the saved data using the communication module.

2. The method as claimed in claim 1, further comprising receiving a user request to acquire visual data, and acquiring visual data pursuant to said user request.

3. The method as claimed in claim 1, comprising video processing by the data processor, on the acquired visual data to identify and determine a license plate number.

4. The method as claimed in claim 3, comprising comparing the determined license plate number with a database that includes a list of license plate numbers and issuing a video or audio alert when the determined license plate number matches a number that appears in the list.

5. The method as claimed in claim 1, comprising video processing, using the data processor, of the acquired visual data to identify a hazardous or potentially hazardous traffic situation, and upon identification of such situation, issuing an audio or video alert.

6. The method as claimed in claim 1, comprising determining whether the identified traffic event is a hazardous or potentially hazardous traffic situation, and upon identification of such situation issuing an audio or video alert.

7. The method as claimed in claim 1, comprising requesting a user to provide identification data relating to an entity selected from a group of entities that includes vehicles and persons.

8. The method as claimed in claim 1, further comprising:
providing a server adapted to communicate over a communication network, with the handheld communication device;
storing on the server the saved data relating to the traffic event;
assigning a score to an entity selected from a group of entities that includes vehicles and persons, the entity relating to the traffic event; and
saving the score in a database that includes a list of scores of a plurality of entities.

9. The method as claimed in claim 1, comprising verifying correct positioning and orientation of the handheld communication device when mounting on the vehicle, using visual indication on a display screen of the handheld communication device.

10. The method as claimed in claim 1, comprising acquiring data from a proximity sensor, processing, using the data processor, acquired proximity data to identify a hazardous or potentially hazardous traffic situation, and upon identification of such situation, issuing an audio or video alert.

11. The method as claimed in claim 1, comprising processing the acquired visual data or motion data using a technique selected from a group of techniques that includes: time stamping, attaching location data, encryption and access control.

12. The method as claimed in claim 1, comprising communicating a notification of the traffic event to a predefined party.

13. The method as claimed in claim 1, comprising displaying the saved data on a display screen of the handheld communication device.

14. A computer readable medium containing computer executable instructions, that when executed cause a data processor of a general purpose handheld communication device including a motion sensor, a video imaging sensor, the data processor, data storage medium, and data communication module to carry out the steps of:
acquiring motion data using the motion sensor, and identifying a traffic event based on the motion data;
acquiring visual data using the video imaging sensor;
saving data that includes the acquired visual data and motion data on the data storage medium; and
communicating the saved data to another device using the communication module.

15. The computer readable medium as claimed in claim 14, wherein the instructions further comprise instructions for: receiving a user request to acquire visual data, acquiring visual data pursuant to said user request and saving the visual data on the data storage medium.

16. The computer readable medium as claimed in claim 14, wherein the instructions further comprise instructions for: video processing by the data processor, on the acquired visual data to identify and determine a license plate number.

17. The computer readable medium as claimed in claim 16, wherein the instructions further comprise instructions for: comparing the determined license plate number with a database that includes a list of license plate numbers and issuing a video or audio alert when the determined license plate number matches a number that appears in the list.

18. The computer readable medium as claimed in claim 14, wherein the instructions further comprise instructions for: video processing, using the data processor, of the acquired visual data to identify a hazardous or potentially hazardous traffic situation, and upon identification of such situation, issuing an audio or video alert.

19. The computer readable medium as claimed in claim 14, wherein the instructions further comprise instructions for: determining whether the identified traffic event is a hazardous or potentially hazardous traffic situation, and upon identification of such situation issuing an audio or video alert.

20. The computer readable medium as claimed in claim 14, wherein the instructions further comprise instructions for: requesting a user to provide identification data relating to an entity selected from a group of entities that includes vehicles and persons.

21. The computer readable medium as claimed in claim 14, wherein the instructions further comprise instructions for: verifying correct positioning and orientation of the handheld communication device when mounting on the vehicle, using visual indication on a display screen of the handheld communication device.

22. The computer readable medium as claimed in claim 14, wherein the instructions further comprise instructions for: acquiring data from a proximity sensor, processing, using the data processor, acquired proximity data to identify a hazardous or potentially hazardous traffic situation, and upon identification of such situation, issuing an audio or video alert.

23. The computer readable medium as claimed in claim 14, wherein the instructions further comprise instructions for: processing the acquired visual data or motion data using a technique selected from a group of techniques that includes: time stamping, attaching location data, encryption and access control.

24. The computer readable medium as claimed in claim 14, wherein the instructions further comprise instructions for: communicating a notification of the traffic event to a predefined party.

25. The computer readable medium as claimed in claim 14, wherein the instructions further comprise instructions for: displaying the saved data on a display screen of the handheld communication device.
